(19) United States
(12) Patent Application Publication
(10) Pub. No.: US 2005/0055792 A1
(43) Pub. Date: Mar. 17, 2005

(54) Autonomous vacuum cleaner

(76) Inventors: David Kisela, Cuyahoga Falls, OH (US); Robert A. Vystrcil, Garrettsville, OH (US); Robert N. McKee, Aurora, OH (US); Wallace D. Tiller JR., Stow, OH (US)

Correspondence Address: Jay F. Moldovanyi, Esq.;Fay, Sharpe, Fagan, Minnich & McKee, LLP, Seventh Floor, 1100 Superior Avenue, Cleveland, OH, 44114-2518, US

(21) Appl. No.: 10/662,247

(22) Filed: Sep. 15, 2003

(51) Int. Cl. A47L 5/00

(52) U.S. Cl. 15/319

(57) ABSTRACT

An autonomous vacuum cleaner includes a first module, a hose connected at a first end to the first module and a second module spaced from the first module and connected to a second end of the hose. The first module includes a suction source. The hose is in fluid communication with the suction source. The second module includes a drive housing including a drive system to propel the second module and a nozzle section pivotally mounted to the drive housing. The nozzle section includes a suction opening in fluid communication with the hose.

### BACKGROUND OF THE INVENTION

The invention relates to an autonomous vacuum cleaner. It finds particular application in conjunction with a robotic vacuum having a controller module, a cleaning head module, and an interconnecting hose and will be described with particular reference thereto. However, it is to be appreciated that the invention is also amenable to other applications, such as, for example, a single module robotic vacuum cleaner.

Generally, there are two standard types of vacuum cleaners: upright and canister. Uprights tend to be more popular in the United States because they are easier to manipulate and less expensive to manufacture. Conversely, the principal advantage of canister vacuums, which are more popular in Europe, is that, while the canister may be more cumbersome, the cleaning head is smaller.

It is well known that robots and robot technology can automate routine household tasks, eliminating the need for humans to perform these repetitive and time-consuming tasks. Currently, technology and innovation are both limiting factors in the capability of household cleaning robots. Computer processing power, battery life, electronic sensors, such as cameras, and efficient electric motors are all either just becoming available, cost effective, or reliable enough to use in autonomous consumer robots.

Much of the work on robotic vacuum cleaner technology has centered on navigation and obstacle detection and avoidance. The path of a robot determines its success at cleaning the entire available floor surface of a room, while navigating around obstacles such as furniture, and dictates whether or not it will get stuck. Some proposed systems have two sets of orthogonal drive wheels to enable the robot to move directly between any two points to increase its maneuverability. Many robotic vacuums also include methods for detecting and avoiding obstacles. Some known robotic vacuum cleaners have mounted the suction nozzle on a pivoting or transverse sliding arm so as to increase the reach of the robot. Recently, several patents and published patent applications have disclosed self-propelled and autonomous vacuum cleaners.

For example, U.S. Pat. No. 6,226,830 to Hendriks et al. and assigned to Philips Electronics discloses a self-propelled canister-type vacuum cleaner. The canister includes an electric motor, a caster wheel, two drive wheels, a controller, and at least one touch or proximity sensor. The controller controls at least the direction of at least one of the drive wheels. The vacuum cleaner also includes a conventional cleaning head and a hose assembly connecting the cleaning head to the canister. As a user operates the vacuum cleaner and controls the cleaning head, the sensors in the canister detect obstacles and the controller controls the canister to avoid the obstacles.

U.S. Pat. No. 6,370,453 to Sommer discloses an autonomous service robot for automatic suction of dust from floor surfaces. The robot is controlled so as to explore the adjacent area and to detect potential obstacles using special sensors before storing them in a data field. The displacement towards a new location is then carried out using the stored data until the whole accessible surface has been covered. One of the main constituent members of the robot includes an extensible arm that rests on the robot and on which contact and range sensors are arranged. When the robot is used as an automatic vacuum cleaner, airflow is forced into the robot arm. When one or more circular rotary brushes are provided at the front end of the arm, the cleaning effect is enhanced.

U.S. Pat. No. 6,463,368 to Feiten et al. discloses a self-propelled vacuum cleaner. The vacuum cleaner includes a pivotable arm and a cable to connect to an electrical receptacle for power. The arm includes a plurality of tactile sensors to recognize obstacles by touching the obstacle with the arm. The vacuum cleaner also includes a processor and a memory connected via a bus. An identified and traversed path is stored in an electronic map in the memory. Every obstacle identified on the path is entered in the map. The vacuum cleaner includes a cable drum for winding up the cable. The cable drum includes a motor to drive the cable drum for unwinding or winding the cable. The vacuum cleaner also includes a steering mechanism, wheels, and a motor for driving the vacuum cleaner along the path.

PCT Published Patent Application No. WO 02/074150 to Personal Robotics discloses a self-propelled canister vacuum cleaner. In one embodiment, the vacuum cleaner is autonomous. In another embodiment, the self-propelled vacuum cleaner is powered by standard utility power via a power cord. The canister vacuum cleaner includes a cleaning head module, a vacuum fan module (i.e., canister), and a hose assembly connecting the cleaning head module with the vacuum fan module. The vacuum fan module includes a controller that performs navigation and control functions for both the vacuum fan module and the cleaning head module. Alternatively, the controller may be separated from the vacuum fan module and the cleaning head module, and can be mobile. The vacuum fan module and the cleaning head module each include a drive mechanism for propulsion. The cleaning head module includes a cleaning brush assembly that can be motorized or air driven. The cleaning head module may also include a microcontroller that communicates with the controller.

U.S. patent application Ser. No. 10/423,588, filed Apr. 25, 2003 which is assigned to the assignee of this application and incorporated herein by reference also discloses a self-propelled canister vacuum cleaner. The vacuum portion is removable to provide a portable vacuum cleaner.

However, the current two component robotic vacuum cleaners lack a free-floating nozzle section to provide a cleaning head that is more versatile. Additionally, current robotic canister-like vacuum cleaners do not make the cleaning head as compact as possible with improved bumpers. Accordingly, a need exists to overcome the aforementioned shortcomings and others while providing a better and more advantageous design.

### BRIEF SUMMARY OF THE INVENTION

Thus, there is a particular need for an improved autonomous vacuum cleaner. The invention contemplates a robotic vacuum cleaner that overcomes the above- mentioned shortcomings as well as others.

In one aspect of the invention, an autonomous vacuum cleaner includes a first module, a hose connected at a first end to the first module and a second module spaced from the first module and connected to a second end of the hose. The first module includes a suction source. The hose is in fluid communication with the suction source. The second module includes a drive housing including a drive system to propel the second module and a nozzle section pivotally mounted to the drive housing. The nozzle section includes a suction opening in fluid communication with the hose.

In another aspect of the invention, an autonomous vacuum cleaner includes a first module housing a suction source and a dirt container. The autonomous vacuum cleaner further includes a hose connected at a first end to the first module and a second module space from the first module and connected to a second end of the hose. The second module includes a suction opening in fluid communication with the hose, a drive system to propel the second module and at least one bumper attached to the second module by an attachment arm.

Benefits and advantages of the invention will become apparent to those of ordinary skill in the art upon reading and understanding the description of the invention provided herein.

### BRIEF DESCRIPTION OF THE DRAWINGS

The invention is described in more detail in conjunction with a set of accompanying drawings, wherein:

FIG. 1 is a functional block diagram of an embodiment of an autonomous vacuum cleaner according to the present invention;

FIG. 2 is an enlarged functional block diagram showing a suction airflow path of the vacuum cleaner of FIG. 1;

FIG. 3 is a top perspective view of a cleaning head module of the vacuum cleaner of FIG. 1;

FIG. 4 is an exploded perspective view of a drive housing of the cleaning head module of FIG. 3;

FIG. 5 is an exploded perspective view of a drive system of the cleaning head module of FIG. 3;

FIG. 6 is a top plan view in cross section of the cleaning head module of FIG. 3;

FIG. 7 is a bottom perspective view of the cleaning head module of FIG. 3;

FIG. 8 is a rear elevational view of the cleaning head module of FIG. 3;

FIG. 9 is a side elevational cross-sectional view of the cleaning head module of FIG. 6 along line 9-9; and

FIG. 10 is an exploded perspective view of a nozzle section of the cleaning head module of FIG. 3.

### DETAILED DESCRIPTION OF THE INVENTION

While the invention is described in conjunction with the accompanying drawings, the drawings are for purposes of illustrating an exemplary embodiment of the invention and are not to be construed as limiting the invention to such embodiments. It is understood that the invention may take form in various components and arrangements of components beyond those provided in the drawings and the following associated description.

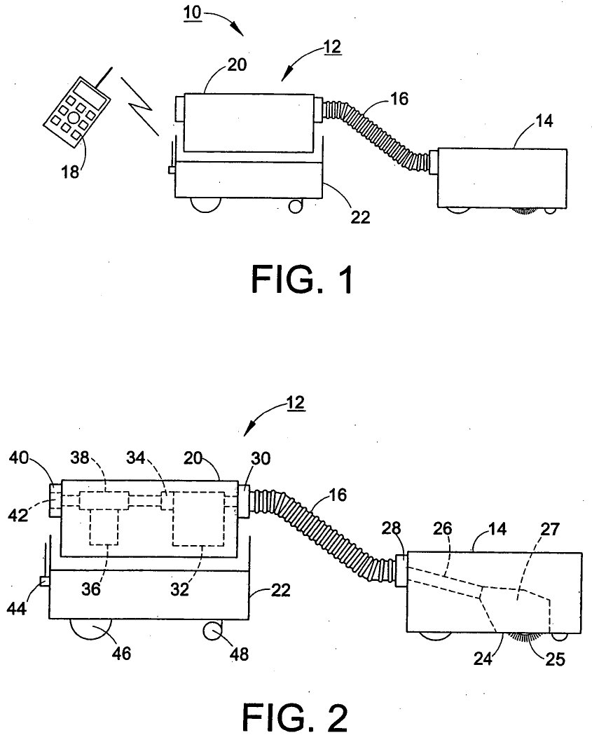

With reference to FIG. 1, an embodiment of an autonomous or robotic vacuum 10 includes a first or controller module 12 and a second or cleaning head module 14. A hose 16 connects the controller module to the cleaning head module. For the sake of brevity, the controller module will be referred to as the controller and the cleaning head module will be referred to as the cleaning head. The robotic vacuum 10 can also include an optional remote control 18 to allow an operator to control the controller module, the cleaning head module, or both. Otherwise, the controller 12 regulates the operation of the cleaning head 14. The controller 12 includes a vacuum module 20 and a transport module 22. In this embodiment, the autonomous vacuum 10 resembles a conventional canister vacuum with the cleaning head spaced from the controller.

The vacuum module 20 is carried by the transport module 22 and is in fluidic communication with the cleaning head 14 via the hose 16. If used, the remote control 18 would be in operative communication with the controller 12 and the controller would be in operative communication with the cleaning head module 14. The controller 12 can communicate with the cleaning head 14 via data lines (not shown) in the hose. In one embodiment, one data line could provide directional information to the cleaning head 14 and a second data line could provide sensor information from the cleaning head to the controller. Also, a power line could extend through the hose or on the hose to provide power to the cleaning head. Alternatively, both power and information can be sent over the same line. In another embodiment, the controller 12 could communicate with the cleaning head 14 via an RF emitting device in communication with a receiver in the cleaning head. In yet another embodiment, the controller and the cleaning head can communicate via infrared receivers and transmitters.

The controller 12 and the cleaning head 14 cooperate by moving in tandem across a surface area to vacuum dirt and dust from the surface. Typically, the cleaning head 14 acts as a slave to the controller 12, which is the master, for robotic cleaning operations. Since the cleaning head 14 is separate from the controller 12 in a tandem configuration, the cleaning head 14 can be significantly smaller than the controller 12 and smaller than known one-piece robotic vacuum cleaners. This arrangement allows the small cleaning head 14 to access and clean small or tight areas, including under and around furniture. In one embodiment, the vacuum portion 20 can be removed from the transport module 22 for use as a vacuum or blower for manual operations. Furthermore, the hose 16 can stretch up to three times its unstretched length, thus allowing the cleaning head to access areas well away from the controller.

The controller 12 can perform mapping localization, planning and control for the robotic vacuum 10. If used, the remote control 18 would allow a user to control the direction the robotic vacuum moves throughout the surface area. While the user is performing this function, the controller 12 can learn and map a floor plan for the surface area including any existing stationary objects.

With reference to FIG. 2, various functions of the major components of the robotic vacuum 10 are shown, including the suction airflow path associated with vacuuming functions. Following the path of airflow through the robotic vacuum 10, the cleaning head 14 includes a suction inlet 24, and a brushroll 25. The brushroll may be mounted in a brushroll chamber 27 which communicates with the suction inlet 24 and with a conduit 26 and a cleaning head outlet 28. The cleaning head is mounted on several wheels or casters as will be discussed in detail below.

The vacuum module 20 includes a vacuum inlet 30, a dirt receptacle 32, a primary filter 34, a motor 36, a fan 38, an air exhaust outlet 40 and a secondary filter 42. The motor 36 and the fan 38 are operatively engaged when the motor 36 is powered. The fan 38 creates an airflow path pulling a suction at the suction inlet 24 by blowing air through the air exhaust outlet 40. Air is drawn into the airflow path at the suction inlet 24. Thus a suction airflow path is created between the suction inlet 24 and the fan 38. The motor and fan assembly is only one possible suction source contemplated by the invention. Other conventional suction sources, such as a pump or the like could be substituted. The vacuum or lower pressure in the suction airflow path draws dirt and dust particles in the suction inlet 24. The dirt and dust particles are retained in the dirt receptacle 32. The dirt receptacle 32 may be dirt cup or canister or a disposable bag, depending on whether a bag-less or bagged configuration is implemented.

Additionally, as shown in FIG. 2, the transport module 22 can include an antenna 44, a wheel 46 (only one shown) and a caster 48. The transport module can include a drive system that includes a motor (not shown) to propel the controller. The cleaning head 14 also includes devices to propel the cleaning head across the floor and these will be described in more detail with reference to the following figures.

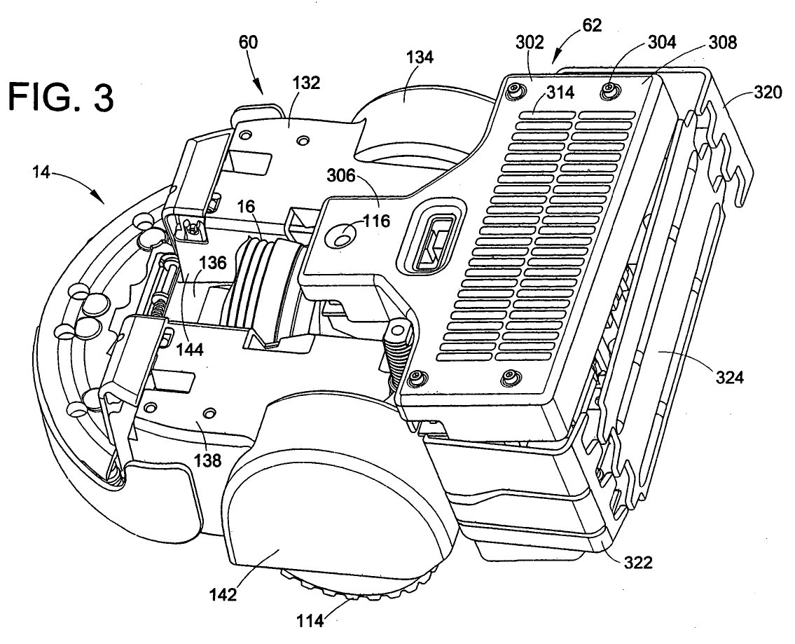

With reference to FIG. 3, the cleaning head module 14 includes a first section or drive housing 60 and a second or nozzle section 62 pivotally connected to the drive housing. The drive housing and nozzle section can be made from a suitable conventional plastic or metal or some other durable material. The nozzle section 62 is pivotally connected to the drive housing 60 so that the nozzle section floats in relation to the drive housing. This floating hinge connection will be described in more detail below. The cleaning head will be described using such terms as up upper, lower, left, and right, and other directional terms, simply for the ease of understanding the figures. Such terms are not meant to limit the invention to only those configurations described. Also, for the ease of understanding the nozzle section 62 will be referred to as being in front of the drive housing 60.

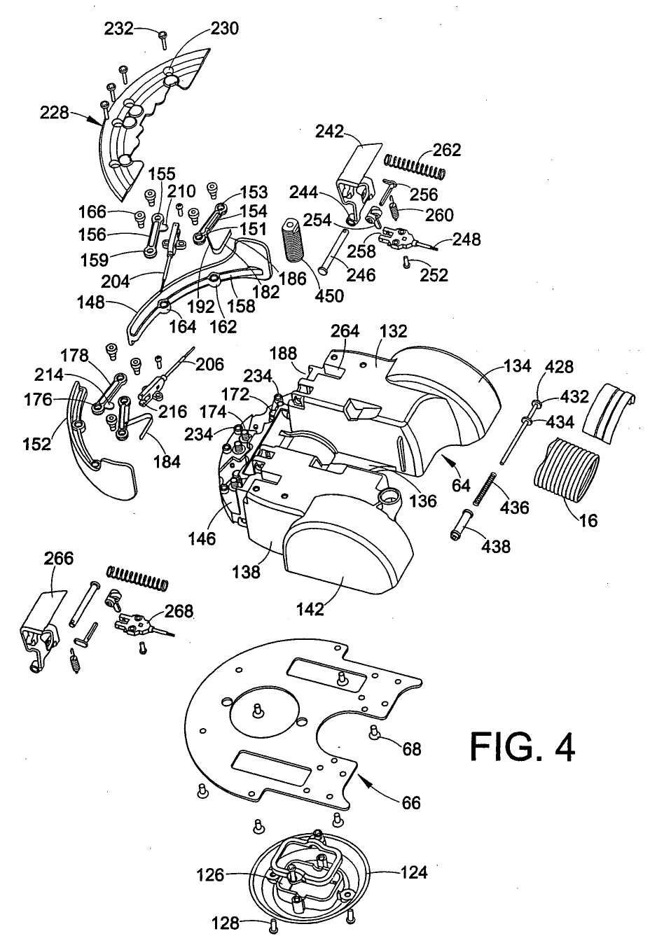

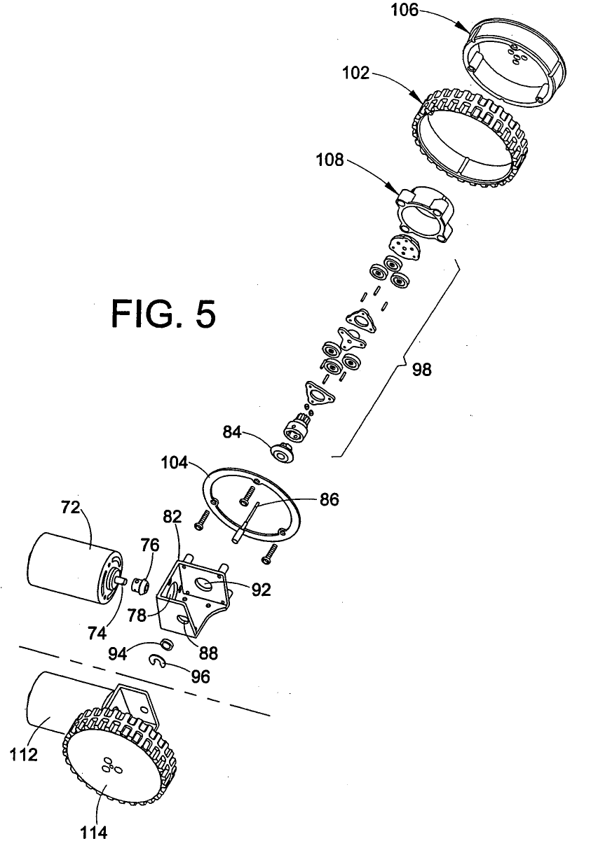

Referring to FIG. 4, the drive housing 60 includes a chassis 64 and a base plate 66 attached to the chassis via conventional fasteners 68. The drive housing 60 at least partially encloses a drive system. With reference to FIG. 5, the drive system includes a first or left drive motor 72 having an output shaft 74. A pinion 76 mounts to the output shaft 74. The pinion 76 protrudes through an opening 78 of a mounting frame 82 and engages a gear 84 mounted on an axle 86. The axle 86 fits into an opening 88 for support and protrudes through an opening 92 on an opposite side of the mounting frame 82. A spacer 94 and a clip 96 mount to the axle 86 so that the axle does not slide through the opening 88.

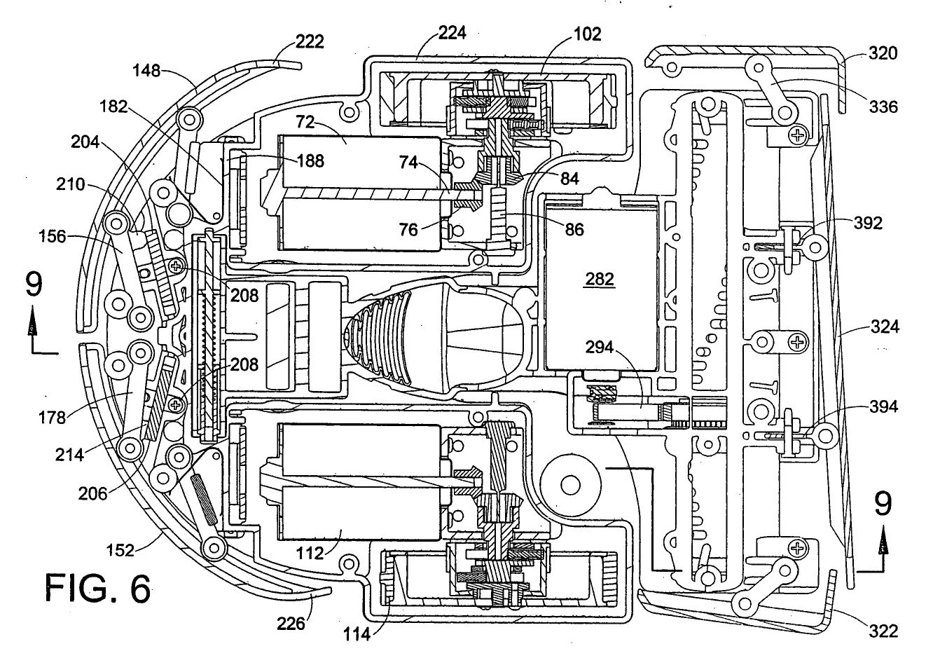

A gear reduction assembly 98 mounts to the axle 86 and a driven wheel 102 attaches to the gear reduction assembly. The gear reduction assembly comprises a plurality of conventional gears and components that can reduce the high RPM output of the motor to lower the RPM translated to the driven wheel 102. A gear reduction assembly housing 108 encloses the gear reduction assembly 98 and attaches to the mounting frame 82. The driven wheel 102 also includes a rim 104 mounted to a hub 106 received by the wheel. Accordingly, the motor 72 drives the driven wheel 102, and the gear reduction assembly 98 decreases the high RPM output of the motor to a lower RPM for driving the wheel. With reference to FIG. 6, to minimize the width of the drive housing 60 the output shaft 74 of the motor is situated substantially perpendicular to the axle 86.

As also seen in FIGS. 5 and 6, the drive system includes a second or right motor 112 that drives right driven wheel 114. The transmission between the motor 112 and the driven wheel 114 is the same as that described for the left motor 72 and the left driven wheel 102. For the sake of brevity, the description is not supplied.

Connected to each wheel 102 and 114 can be an odometer (not shown). Each odometer can include an encoder (not shown) that communicates with the controller 12 or other control circuitry on the autonomous vacuum cleaner to calculate how far each wheel has traveled by multiplying the circumference of the wheel by the number of rotations of the wheel. Such information can be used for positioning of the cleaning head.

Each driven wheel 102 and 114 can also be driven independently of the other. For example, if the left driven wheel 102 is propelled forward at a faster speed than the right driven wheel 114, the cleaning head will turn along an arc to the right. Also, the driven wheels can be propelled in opposite directions such that the cleaning head 14 can rotate about its geometric center 116 (FIG. 3). The motors 72 and 112 can engage the driven wheels 102 and 114 via a clutchless transmission, and accordingly the motors can be of the type that can drive an output shaft in opposite directions of rotation.

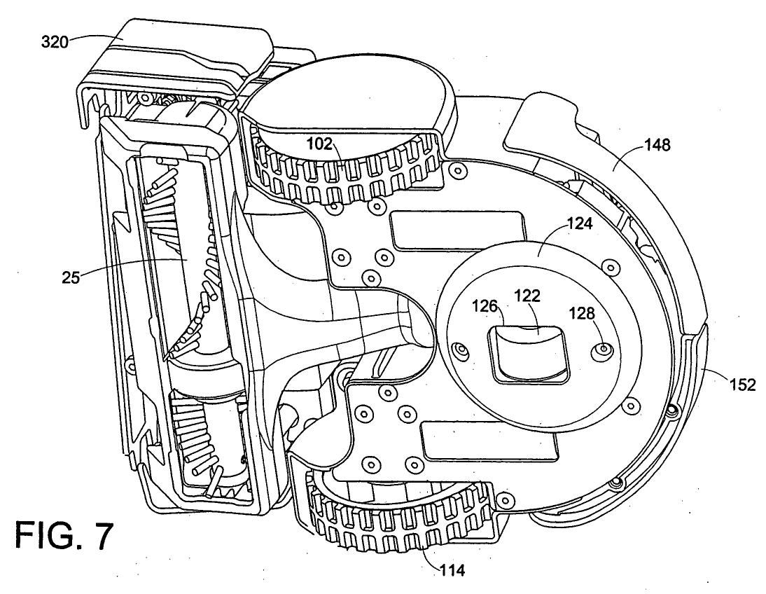

As best viewed in FIG. 7, the drive system also includes an omni wheel 122 mounted to an underside of the cleaning head. An omni wheel comprises a wheel that can turn around two perpendicular axes simultaneously. More particularly, while the wheel rotates about a horizontal axis, its housing can rotate about a vertical axis. This construction allows the wheel to function in the same manner as a caster wheel. The omni wheel 122 is centrally located on the bottom of the drive housing 60.

Accordingly, the left driven wheel 102, the right driven wheel 114 and the omni wheel 122 are situated about 120( apart from one another thus forming a triangular configuration. Mounted to the base plate 66 of the drive housing 60, a skid plate 124, having an opening 126 with the omni wheel protruding through it, protects the omni wheel. The skid plate 124 mounts to the base plate 66 via conventional fasteners 128. In an alternative embodiment, more than one omni wheel can be provided on the cleaning head. Furthermore, conventional casters can be provided additionally to the omni wheel or in lieu thereof.

With reference back to FIG. 3, the drive system, as mentioned above, is at least partially enclosed by the drive housing 60. As seen in FIG. 4, the drive housing includes the chassis 64 and the base plate 66. The chassis includes a left drive housing portion 132 that encloses the left drive motor. A left driven wheel housing portion 134 is positioned adjacent the left drive housing portion and at least partially encloses the left driven wheel. Spaced from the left drive housing portion and connected by a lower wall 136, a right drive housing portion 138 at least partially encloses the right drive motor. Similarly, a right driven wheel housing portion 142 is positioned adjacent the right drive housing portion and at least partially encloses the right driven wheel 114 (FIG. 3). The left drive housing portion 132 is spaced from the right drive housing portion 138 such that the drive housing portions and the lower wall 136 interconnecting the two define a channel 144 that is adapted to receive the hose 16.

With continued reference to FIG. 4, the chassis 64 also includes a rear mounting wall 146 to which rear bumpers 148 and 152 mount. In an alternative embodiment, only one bumper can be mounted to the drive housing, or alternatively a plurality of bumpers can mount to the drive housing. The left bumper 148 attaches to the mounting wall 146 of the chassis 64 via attachment arms 154 and 156. The attachment arms each include apertures at each end, distal apertures 153 and 155, respectively, and proximal apertures 157 and 159, respectively. The left bumper includes a flange 158 having openings 162 and 164. Received in the openings 162 and 164 and apertures 153 and 155 are conventional fasteners 166 to fasten the attachment arms 154 and 156 to the bumper 148. The mounting wall 146 also includes openings 172 and 174 and fasteners 166 are received through apertures 157 and 159 and openings 172 and 174 to attach each attachment arm to the rear mounting wall.

The right bumper 152 attaches in much the same manner as the left bumper 148. Attachment arms 176 and 178 attach the right bumper to the mounting wall 146 and the attachment is the same as for the left bumper. For the sake of brevity, description of the attachment is not provided.

The bumpers 148 and 152 resiliently attach to the mounting wall 146. Wire form springs 182 and 184 provide the resiliency for the bumpers. For the sake of brevity only the left bumper spring 182 will be described, since the springs are mirror images of one another. The left wire form spring 182 is positioned resting on the mounting wall 146 and having a first leg 186 abut against a rear wall 188 (best viewed in FIG. 6) of the left drive housing portion 122. A second leg 192 of the left wire form spring 182 abuts against a portion of the attachment arm 154 such that when the right bumper 148 contacts an object the bumper can deflect slightly. Other biasing members, such as a helical spring to name just one, can also be used to bias the bumper.

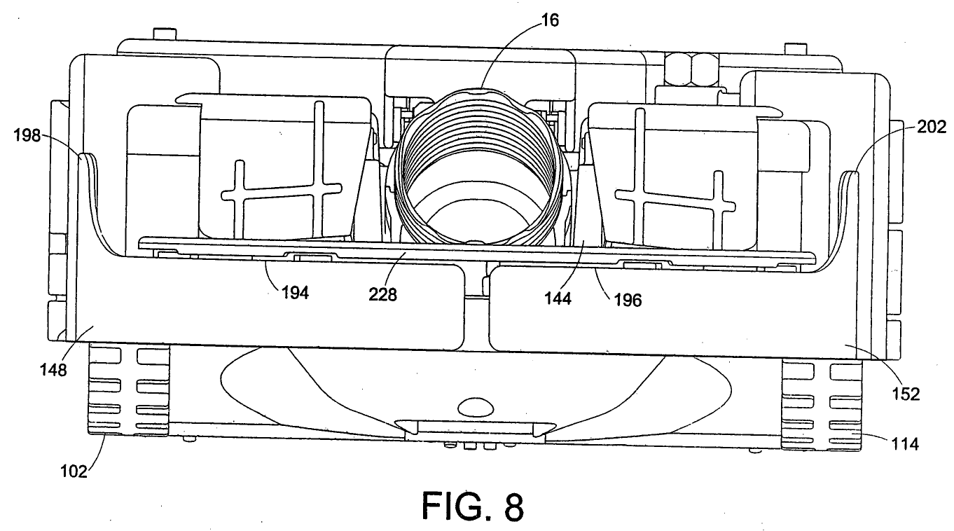

With reference to FIG. 8, the left bumper 148 and the right bumper 152 each include an indented central portion defined at an edge 194 on the left bumper 148 and at an edge 196 on the right bumper 152. The edges 194 and 196 are positioned below respective outer upper edges 198 and 202. As the cleaning head 14 rotates or turns, the hose 16 can travel along the indented central portion defined between the edges 198 and 202. Furthermore, the channel 144 is sized such that the hose 16 is accommodated in the channel so that a highest point of the hose is positioned below a highest point of the cleaning head 14. Such a configuration allows the cleaning head 14 to have a reduced height so that it can maneuver underneath objects as it vacuums.

With reference back to FIG. 6, sensors 204 and 206 mount to the mounting wall 146 near the attachment arms 156 and 178 respectively via conventional fasteners 208. The sensors can include shutter interfaces with infrared switches. Attachment arm 156 includes a shutter 210 that can move into a recess 212 (visible in FIG. 4) in the sensor 204, thus actuating the sensor to communicate with the drive system. Likewise, attachment arm 178 includes a shutter 214 that can move into a recess 216 (visible in FIG. 4) in the sensor 206, thus actuating the sensor to communicate with the drive system. The sensors are more particularly described in a co-pending application entitled Sensors and Associated Methods for Controlling a Vacuum Cleaner, Ser. No. ______, filed on ______ which is incorporated herein by reference in its entirety.

As shown in FIG. 6, the bumpers 148 and 152 are rounded and together form a substantially semi-circular configuration. An end 222 of the left bumper 148 is positioned adjacent an outer wall 224 of the left wheel housing portion 134. This end 222 terminates near the vertical plane of the outer wall 224 so that object can be detected when the cleaning head is moving backwards before the wheel housing portion would contact it. The right bumper 152 includes a similar end 226 positioned adjacent the right wheel housing portion 142. It is apparent that the right bumper 152 is shown as being pushed in, in relation to its normal position, which can be seen when comparing it to the left bumper. Also visible in FIG. 6, is that when the right bumper 152 is pushed in the shutter 214 of the attachment arm 178 moves into the recess 216 (FIG. 4), thus activating the sensor 206.

With reference once more to FIG. 4, a rear bumper arm cover plate 228 mounts to the mounting wall 146 to cover the attachment arms. The rear bumper arm cover plate 228 includes openings 230 that receive conventional fasteners 232 that are received in openings 234 in the mounting wall.

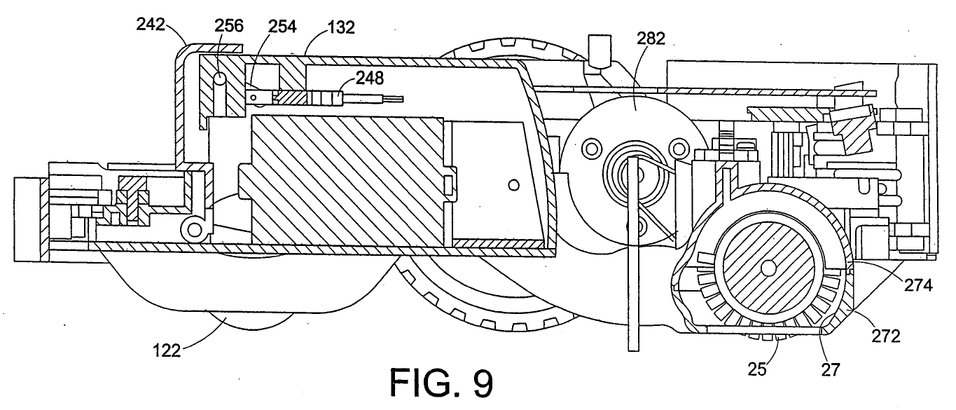

A left upper bumper 242 attaches to the rear of the chassis 64. The left upper bumper 242 includes hoops 244 to receive a pin 246 to pivotally attach the left upper bumper to the chassis. The pin 246 is received in an opening (not visible) in the chassis 64 at the rear side of the left drive housing portion 132 (FIG. 9). A sensor 248, similar to the one described mounted near the rear bumpers, mounts to an underside of the left drive housing portion 132 via a conventional fastener 252. A shutter 254 mounts to the left upper bumper via a shutter pin 256. The shutter 254 can move in and out of a recess 258 in the sensor 248 to activate the sensor. The shutter is biased by a spring 260 and the upper bumper 242 is biased also by a spring 262. The bumper biasing spring 262 can mount inside a channel 264 defined in the left drive housing portion 132.

A right upper bumper 266 also mounts to the chassis 64 and communicates with a sensor 268 in much the same manner as left upper bumper 242 and left sensor 248. Therefore, for the sake of brevity, its description will not be supplied.

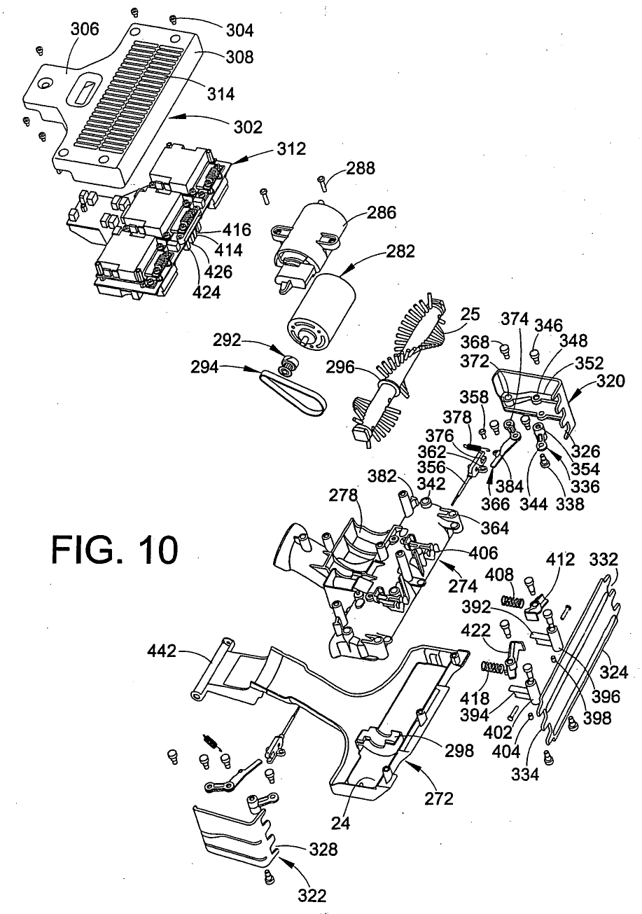

With reference to FIG. 10, the nozzle section 62 of the cleaning head module 14 includes a lower nozzle portion 272 that connects to an upper nozzle portion 274 to define the suction conduit 26. The lower nozzle portion and the upper nozzle portion also cooperate to define a brushroll chamber 27 (FIG. 9), as well as the suction opening or inlet 24. The upper nozzle portion 274 includes a motor seat 278 that can receive a brushroll motor 282 that drives the brushroll 25 disposed in the brushroll chamber 27. The motor can receive power through circuitry in a wire harness (not shown) connecting the drive housing 60 to the nozzle section 62. A motor cover 286 attaches to the motor seat 278 to enclose the motor via conventional fasteners 288. The brushroll motor powers the brushroll via a sprocket 292 that engages a belt 294. The brushroll motor 282 powers the belt 294 which is looped around the brushroll to rotate same. In an alternative embodiment, the motor could engage the brushroll via a belt-less transmission.

The brushroll 25 includes a flange 296 that the belt engages. The flange 296 is received in a housing 298 that is a part of the lower nozzle portion 272. The housing 298 protects the belt from dust and dirt that is sucked into the brushroll chamber 27.

With reference once more to FIG. 3, the nozzle section 62 also includes a cover 302 mounted to the upper nozzle portion 274 via fasteners 304. The cover 302 includes a stem 306 at its rear that is received in an upper portion of the channel 144 and a wider front portion 308 having a width substantially equal to the suction opening 26. Referring back to FIG. 10, sandwiched between the cover 302 and the upper nozzle portion 274, a printed circuit board provides 312 provides a surface to mount sensors, encoders and the like that will direct the cleaning head module or receive instructions from the controller modular 12. The sensors and encoders are more particularly described in co-pending application entitled Sensors and Associated Methods for Controlling a Vacuum Cleaner. Ser. No. ______, filed on ______. The cover 302 of the nozzle section includes slots 314 to allow airflow to cool the printed circuit board. Furthermore, the cover can include sensors to detect overhead obstructions.

The nozzle section 62 includes a left corner bumper 320, a right corner bumper 322 and a front bumper 324 positioned between the left corner bumper and the right corner bumper. The corner bumpers 320 and 322 each have a scalloped or serrated edge 326 and 328 respectively. The front bumper 324 also includes a scalloped edge 332 at one end that complements the scalloped edge 326 of the left front bumper and a scalloped edge 334 at the other end that complements the scalloped edge 328 of the right front bumper 322. The scalloped edges allow the bumpers to cover more ground. In other words, if the cleaning head module 14 contacts an obstruction near a corner of the cleaning head both the front bumper 324 and a corner bumper 320 or 322 can transmit a signal to the drive motors so that the cleaning head can move to avoid the obstruction in the future.

The left corner bumper 330 attaches to the upper nozzle portion 274 via an attachment arm 336. The attachment arm attaches to the upper nozzle portion 274 via a fastener 338 received in an opening 342 in the upper nozzle portion and an opening 344 in the attachment arm. The attachment arm pivotally attaches to the left corner bumper via a fastener 346 received in an opening 348 in a flange 352 of the bumper and an opening 354 in the attachment arm. A sensor 356 mounts to the upper nozzle portion 274 via a fastener 358 received in an opening 362 in the sensor and an opening 364 in the upper nozzle portion. A shutter 366 mounts to the left corner bumper 320 via a fastener 368 received in an opening 372 in the bumper and an opening 374 in the shutter. The shutter can fit into a recess 376 in the sensor 356 to activate the sensor. A spring 378 can bias the shutter 366 away from the recess 376 until the bumper contacts an object. At one end the spring attaches to a projection 382 of the upper nozzle portion. At an opposite end of the spring, it attaches to a projection 384 on the shutter. Likewise, the right corner bumper 332 attaches to the upper nozzle portion in much the same manner as the left corner bumper, and for the sake of brevity a detailed description of the attachment is not provided.

The front bumper 324 attaches to the upper nozzle portion 274 via attachment arms 392 and 394. The first or left attachment arm 392 includes a cylinder 396 that receives a post 398 mounted to a rear side of the front bumper. Similarly, the second or right attachment arm includes a cylinder 402 that receives a post 404 mounted to a rear side of the front bumper. The attachment arm 392 is received in a left recess 406 in the upper nozzle portion 274. A spring 408 is also received in the recess to bias the front bumper 324. A left front shutter 412 is interposed between the spring 408 and the attachment arm 392. Accordingly, when the bumper 324 contacts an object causing the attachment arm 392 to displace, the shutter pivots forward. This is shown in FIGS. 3 and 6. A sensor 414 having a recess 416 mounts to the circuit board 312. The shutter 412 can pivot into the recess 416 of the sensor 414, thus activating the sensor. The right attachment arm 422 is mounted in much the same manner as the left, including a spring 418, a shutter 422, a sensor 424 and a recess 426 in the sensor. The sensors 414 and 424 communicate with the drive system so that the cleaning head can change direction when it contacts an object. Furthermore, the front bumper pivots about the attachment arms 392 and 394, as shown in FIG. 6.

With reference again to FIG. 4, a nozzle pivot axle 428 connects the nozzle section 62 to the drive housing 60. The nozzle pivot axle includes a distal annular protrusion 432 and an intermediate annular protrusion 434. A compression spring 436 is surrounds the axle 428 having a first end that abuts against the intermediate annular protrusion 434. The axle fits into a hollow nozzle shaft 438 and the second end of the compression spring 436 abuts against the shaft 438 to bias the shaft away from the intermediate protrusion. Referring to FIG. 10, the lower nozzle portion 272 includes an elongated hoop 442 that receives the nozzle pivot axle 428, the compression spring 436 and a portion of the nozzle shaft 438. The hoop 442 is received in a recess 444 (FIG. 4) in the mounting wall 46 of the chassis 64, which is also visible in FIG. 6. The mounting wall includes a notch 446 at one end of the recess 444 that receives a portion of the nozzle shaft 438. Accordingly, the nozzle section 62 is pivotally and removably mounted to the drive housing 60.

With continued reference to FIG. 4, the autonomous vacuum cleaner 10 can also include a floor type sensor 450 that mounts in a floor sensor seat 452 adjacent the right driven wheel housing portion 142. The floor type sensor 450 can communicate with the brushroll motor 282 to control whether the brushroll motor will rotate the brushroll, dependent upon the type of floor surface to be cleaned. Furthermore, the floor type sensor can detect whether there is a lack of a floor, as when the cleaning head goes partially over a stair. In this instance, the floor type sensor is positioned on the cleaning head 14 such that it can detect the absence of a floor, while the cleaning head is still supported on the floor so that the cleaning head can stop and change direction before toppling over the stair.

While the invention has been described in conjunction with a preferred embodiment, it is evident that many alternatives and modifications and variations will be apparent to those skilled in the art. Accordingly, the embodiments of the invention and the preceding description are intended to be illustrative, rather than limiting, of the spirit and scope of the invention. More specifically, it is intended that the invention embrace all alternatives, modifications, and variations of the exemplary embodiments described herein that fall within the spirit and scope of the appended claims or the equivalents thereof.

1. An autonomous vacuum cleaner comprising:
a first module including a suction source;
a hose connected at a first end to said first module and in fluid communication with said suction source; and
a second module spaced from said first module and connected to a second end of said hose, said second module comprising:
a drive housing, including a drive system to propel said second module, and
a nozzle section pivotally mounted to said drive housing, said nozzle section including a suction opening in fluid communication with said hose.

2. The vacuum cleaner of claim 1, wherein said drive system includes a first drive motor operating a first driven wheel and a second drive motor operating a spaced second driven wheel.

3. The vacuum cleaner of claim 2, wherein each of said drive motors includes an output shaft and each of said driven wheels is mounted on an axle, wherein said output shafts are oriented approximately perpendicular to said axles.

4. The vacuum cleaner of claim 2, wherein each of said drive motors engage each of said driven wheels via a clutchless transmission.

5. The vacuum cleaner of claim 1, wherein said drive system includes a first driven wheel and a spaced second driven wheel, wherein each of said wheels can be driven independently of the other.

6. The vacuum cleaner of claim 5, wherein said second module further includes an omni wheel, said omni wheel being spaced from said first and second driven wheels.

7. The vacuum cleaner of claim 5, wherein each of said driven wheels includes a gear reduction mechanism.

8. The vacuum cleaner of claim 5, wherein said first driven wheel can be driven in an opposite direction from said second driven wheel such that said cleaning head module rotates about a point substantially near the geometric center of said second module.

9. The vacuum cleaner of claim 5, wherein each of said driven wheels includes an odometer attached thereto.

10. The vacuum cleaner of claim 1, wherein said second module further includes a bumper, wherein said hose extends over said bumper.

11. The vacuum cleaner of claim 10, wherein said drive housing defines a channel having a bottom wall for receiving a portion of said hose, wherein the bottom wall is positioned such that said hose is accommodated in said channel so that a highest point of said hose is positioned below a highest point of said cleaning head.

12. The vacuum cleaner of claim 1, wherein a bumper is pivotally mounted to said drive housing.

13. The vacuum cleaner of claim 1, wherein said nozzle section includes a brushroll motor and a brushroll mounted adjacent said suction opening, wherein said motor powers said brushroll.

14. The vacuum cleaner of claim 13, further comprising a transmission for connecting said brushroll motor to said brushroll.

15. The vacuum cleaner of claim 14, wherein said transmission comprises at least one of a belt and gear.

16. The vacuum cleaner of claim 13, wherein said second module includes a sensor to detect the type of floor to be vacuumed, wherein said sensor communicates with said brushroll motor.

17. The vacuum cleaner of claim 1, wherein said second module includes at least one bumper attached to said nozzle section.

18. The vacuum cleaner of claim 17, wherein said at least one bumper includes a first corner bumper and a second corner bumper.

19. The vacuum cleaner of claim 18, wherein said at least one bumper further includes a front bumper attached to said nozzle section between said first and second corner bumpers.

20. The vacuum cleaner of claim 19, wherein said front bumper includes a pair of opposed serrated edges and said first corner bumper and said second corner bumper each includes an adjacent serrated edge that complements a respective one of said serrated edges of said front bumper.

21. The vacuum cleaner of claim 1, wherein said second module includes at least one bumper attached to a wall of said drive housing.

22. The vacuum cleaner of claim 21, wherein said at least one bumper includes an indented central portion to accommodate said hose extending thereover.

23. The vacuum cleaner of claim 21, wherein said at least one bumper includes two substantially semicircular bumpers attached to said wall of said drive housing.

24. The vacuum cleaner of claim 23, wherein each of said bumpers terminates with an end that is substantially aligned with an outermost side wall of said drive housing.

25. The vacuum cleaner of claim 1, wherein said second module includes at least one sensor to detect the presence or absence of a floor to be vacuumed.

26. The vacuum cleaner of claim 25, wherein said drive system includes a driven wheel, said sensor spaced far enough from said driven wheel such that said cleaning head module is supported on the floor to be vacuumed when said sensor detects an absence of the floor to be vacuumed.

27. The vacuum cleaner of claim 1, wherein said nozzle section is electronically connected to said drive housing via a wire harness.

28. The vacuum cleaner of claim 1, further comprising a drive system disposed in said first module to propel said first module.

29. An autonomous vacuum cleaner comprising:
a first module including a suction source, a dirt container, and a first drive system for propelling said first module;
a hose connected at a first end to said first module and in fluid communication with said suction source and said dirt container; and
a second module spaced from said first module and connected to a second end of said hose, said second module including
a suction opening in fluid communication with said hose,
a second drive system to propel said second module, and
at least one bumper attached to said second module by an attachment arm.

30. The vacuum cleaner of claim 29, further comprising a biasing member interposed between said attachment arm and a wall of said second module.

31. The vacuum cleaner of claim 29, wherein said attachment arm is pivotally connected to said second module.

32. The vacuum cleaner of claim 29, wherein said attachment arm includes a shutter that communicates with a sensor to detect movement of said arm and to communicate with said drive system.

33. The vacuum cleaner of claim 29, wherein said at least one bumper includes a first substantially semi-circular bumper and a second substantially semi-circular bumper.

34. The vacuum cleaner of claim 29, wherein said at least one bumper includes an indented central portion.

35. The vacuum cleaner of claim 29, wherein said at least one bumper includes an upper bumper.

36. The vacuum cleaner of claim 29, wherein said at least one bumper includes a first bumper having a serrated edge and a second bumper having a serrated edge, wherein the serrated edge of the first bumper complements the serrated edge of the second bumper such that portions of each bumper overlap one another but do not contact one another.

37. The vacuum cleaner of claim 36, wherein said second bumper includes a substantially perpendicular bend to at least partially surround a corner of said second module.
